(19) United States
(12) Patent Application Publication
(10) Pub. No.: US 2008/0062387 A1
(43) Pub. Date: Mar. 13, 2008

(54) ELECTRONIC DEVICE AND PROJECTOR

(75) Inventors: Fu Shiung Shih, Taichung County (TW); Shu Mei Chien, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/852,934

(22) Filed: Sep. 10, 2007

(30) Foreign Application Priority Data
Sep. 11, 2006 (TW) TW95133447

(51) Int. Cl. G03B 21/16; F21V 29/00

(52) U.S. Cl. 353/58; 353/52; 353/57; 353/61; 362/373

(57) ABSTRACT

An electronic device. The electronic device includes a housing, a light source and at least one heat-dissipating member. The light source is disposed in the housing, emitting light. The heat-dissipating member is disposed in the housing for lowing operating temperature of the electronic device and preventing light from escaping the housing.

### BACKGROUND OF THE INVENTION

1. Field of the Invention

The invention relates to a projector, and in particular, to a projector utilizing a cross-flow fan lowering total noise, reducing light leakage. and extending lifetime of the cross-flow fan.

2. Description of the Related Art

Heat dissipation in a conventional projector utilizes axial fans. When the brightness of the light source increases, the temperature of the projector increases accordingly. The size of the axial fan must increase commensurately to maintain heat dissipation.

As shown in FIG. 1, when length L and height W of the axial fan 1 increase proportionally, miniaturization of the projector is compromised. Additionally, gaps C formed between the blades B of the axial fan 1 cause serious light leakages, affecting human eyesight. When applying a fan, the life span of a fan is another important consideration. The heat source of a fan 1 is at its hub H. When the hub H is overheated, the axial fan 1 easily burns out.

### BRIEF SUMMARY OF THE INVENTION

The invention provides an electronic device comprising a housing, a light source and at least one heat-dissipating member. The light source, emitting light, is disposed in the housing. The heat-dissipating member, disposed in the housing, reduces operating temperature of the electronic device and prevents light leaking from the housing.

If the number of the heat-dissipating members is plural, the heat-dissipating members are disposed on different horizontal levels.

The housing can comprise an air outflow surface, at which the heat-dissipating member is disposed.

The housing can alternatively comprise an air inflow surface, at which the heat-dissipating member is disposed.

The housing can, alternatively, comprise an air outflow surface and an air inflow surface wherein there are two heat-dissipating members, disposed at the air outflow surface and the air inflow surface, respectively.

The heat-dissipating member is a cross-flow fan having a length of 12 cm and a height of 4 cm.

The electronic device is a projector.

The invention provides a projector comprising a housing and at least one cross-flow fan disposed in the housing.

If the number of cross-flow fans is plural, the cross-flow fans are disposed on different horizontal level.

The cross-flow fan comprises an axle, an upper plate and a lower plate. The upper plate and the lower plate are disposed on two sides of the axle, respectively.

The cross-flow fan comprises an air inlet and an air outlet opposite thereto. The air inlet and the air outlet are on different horizontal levels.

The housing comprises an air outflow surface. The cross-flow fan is disposed at the air outflow surface.

The housing comprises an air inflow surface. The cross-flow fan is disposed at the air inflow surface.

The housing comprises an air outflow surface and an air inflow surface, and the number of the cross-flow fan is two. The cross-flow fans are disposed at the air outflow surface and the air-inflow surface, respectively.

The cross-flow fan has a length of 12 cm. The cross-flow fan has a height of 4 cm.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an axial fan;

FIG. 2 is an interior view of a projector of the invention;

FIGS. 3A and 3B are side views of the projector of the invention;

FIG. 4 is a side view of an variant embodiment of the projector; and

FIG. 5 is a side view of another variant embodiment of the projector.

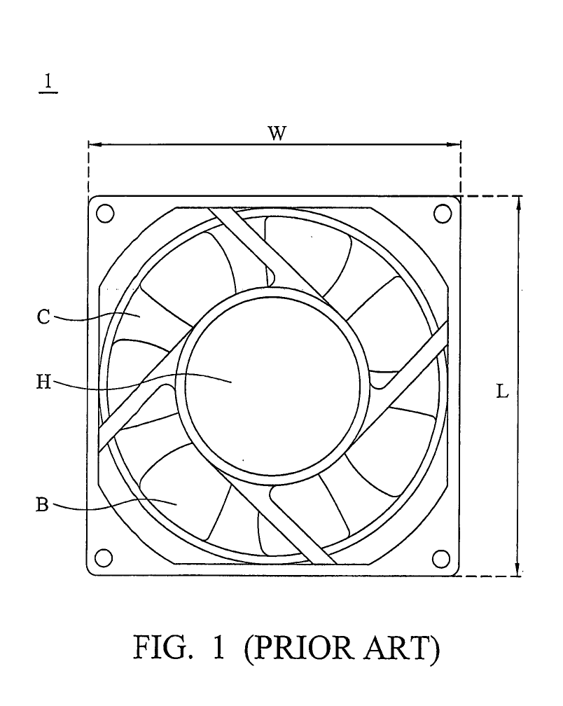

### DETAILED DESCRIPTION OF THE INVENTION

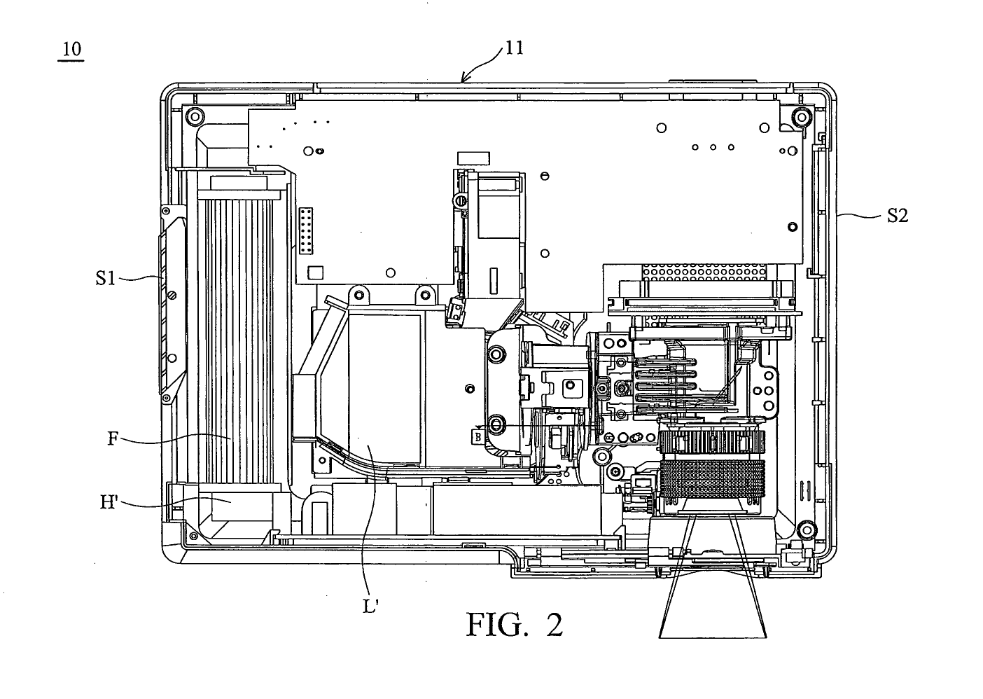

As shown in FIG. 2, in the embodiment, the electronic device is a projector 10 comprising a housing 11, a light source L′ and a heat-dissipating member F. Essential components such as circuit board and optical elements are disposed in the housing 11 as well.

The housing 11 comprises an air outflow surface S1 and an air inlet surface S2 opposite to the air outflow surface S1 correspondingly. The light source L′, a main heat source of the projector, is disposed in the housing 11, adjacent to the air outflow surface S1.

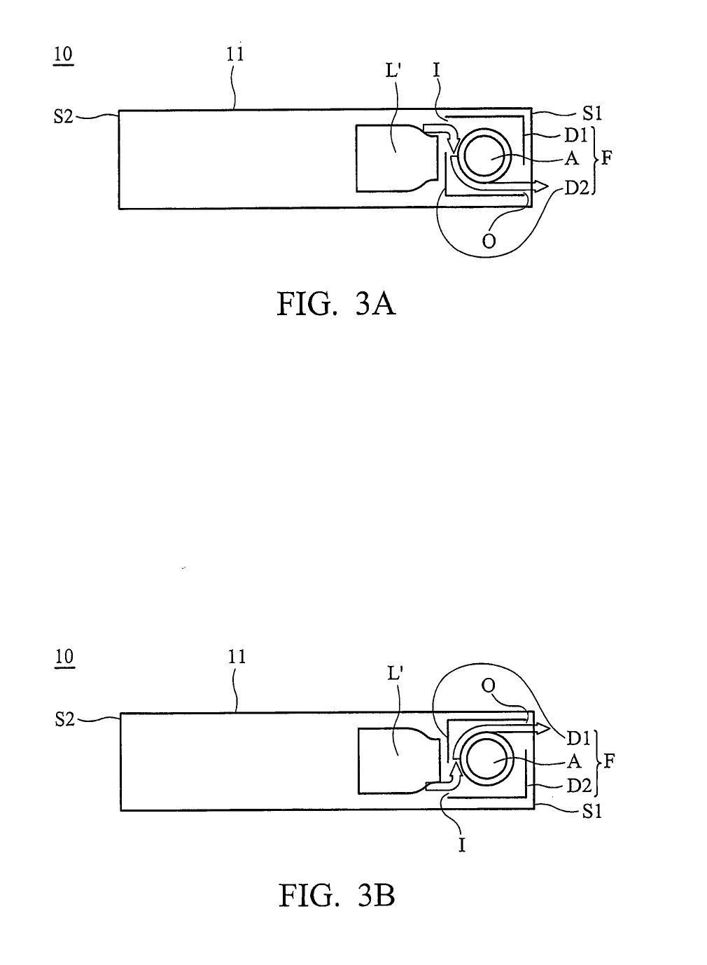

The heat-dissipating member F is a cross-flow fan, and in this embodiment, the length and height of the cross-flow fan are 12 cm and 4 cm. The heat-dissipating member F is disposed at the air outflow surface S1 of the housing 11 for exhausting heat from the projector 10. As shown in FIG. 3A, the heat-dissipating member F comprises an axle A, an upper plate D1 and a lower plate D2. The upper plate D1 and the lower plate D2 are disposed on two sides of the axle A, defining an air inlet I and an air outlet O, wherein the air inlet I and the air outlet O are on different horizontal levels. The path of the airflow is shown in arrows in FIG. 3A. Airflow horizontally enters the air inlet I, passing through the axle A, and out to the air outlet O horizontally.

It should be noted that according to the rotating direction of the axle A and the disposition of the upper plate D1 and the lower plate D2, airflow can enter high and exit low (as shown in FIG. 3A), or airflow can enter low and exit high (as shown in FIG. 3B). However, it is not limited thereto. Otherwise, the heat-dissipating member F

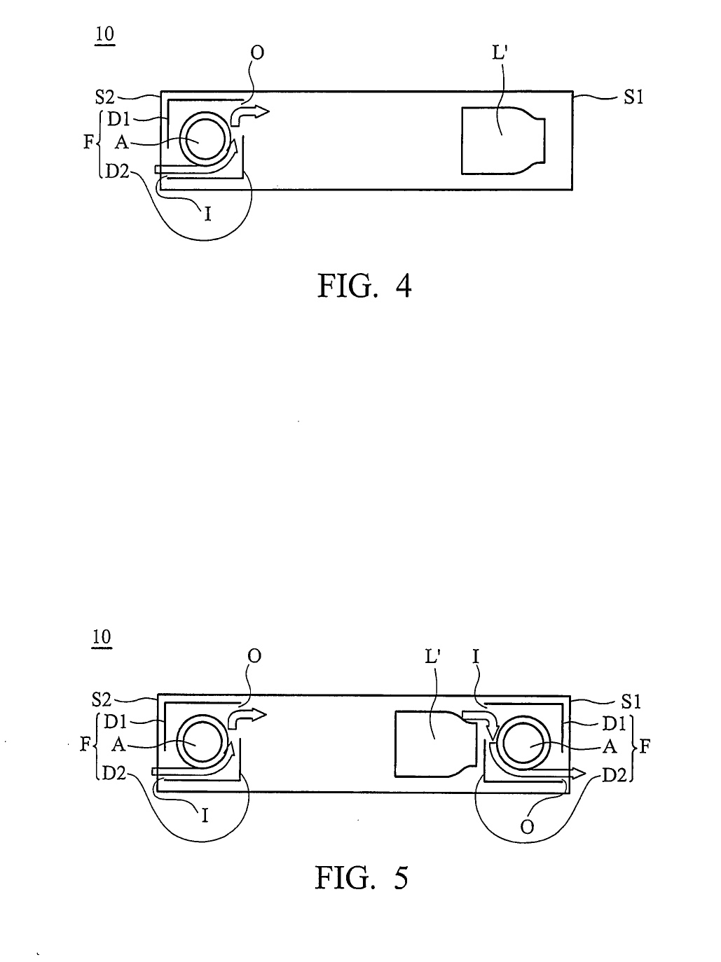

In a variant embodiment, the heat-dissipating member F is disposed at the air inflow surface S2 of the housing 11 (as shown in FIG. 4) for conducting air into. the projector 10. In another variant embodiment, the number of the heat-dissipating members F is two. The two heat-dissipating members F are disposed at the air outflow surface S1 and the air inflow surface S2, respectively, efficiently dissipating heat from the projector 10. Additionally, the two heat-dissipating members F can also be disposed on different horizontal levels.

The projector 10 utilizes cross-flow fans F instead of conventional axial fans to dissipate heat. The reason is that that length of the cross-flow fan varies. according to the size of the projector housing, and the height of the cross-flow fan is relatively low compared to an axial fan, creating a much thinner projector. The air inlet I and the air outlet O of the cross-flow fan F are on different horizontal levels. The height difference between the upper plate D1 and the lower plate D2 effectively prevent light from escaping the housing 11. As a result, the indirect light from the light source L′ is also successfully blocked within the housing 11. Furthermore, a motor H′ (main heat source of the cross-flow fan) of the cross-flow fan F is disposed on a side of the fan (as shown in FIGS. 2). Compared to the centered hub of the axial fan, the motor H′ of the cross-flow fan F is isolated from the light source L′. The heated airflow in the housing 11 does not pass through the motor H′ of the cross-flow fan F, effectively increasing life span of the fan.

While the invention has been. described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a housing;
a light source disposed in the housing and emitting light; and
at least one heat-dissipating member disposed in the housing, lowing operating temperature of the electronic device and preventing light leaking from the housing.

2. The electronic device as claimed in claim 1, further comprising:
two heat-dissipating members disposed on different horizontal levels.

3. The electronic device as claimed in claim 1, the housing comprising an air outflow surface, and the heat-dissipating member disposed at the air outflow surface.

4. The electronic device as claimed in claim 1, the housing comprising an air inflow surface, and the heat-dissipating member disposed at the air inflow surface.

5. The electronic device as claimed in claim 1, the housing comprising:
an air outflow surface;
an air inflow surface; and
two heat-dissipating members respectively disposed at the air outflow surface and the air inflow surface.

6. The electronic device as claimed in claim 1, wherein the heat-dissipating member is a cross-flow fan.

7. The electronic device as claimed in claim 1, wherein the heat-dissipating member has a length of 12 cm.

8. The electronic device as claimed in claim 1, wherein the heat-dissipating member has a height of 4 cm.

9. The electronic device as claimed in claim 1, wherein the electronic device is a projector.

10. A projector, comprising:
a housing; and
at least one cross-flow fan disposed in the housing.

11. The projector as claimed in claim 10, the projector comprising:
two cross-flow fans disposed on different horizontal levels.

12. The projector as claimed in claim 10, the cross-flow fan comprising:
an axle;
an upper plate; and
a lower plate, the upper plate and the lower plate are respectively disposed on two sides of the axle.

13. The projector as claimed in claim 10, the cross-flow fan comprising an air inlet and an air outlet opposite thereto, wherein the air inlet and the air outlet are on different horizontal levels.

14. The projector claimed in claim 10, wherein the housing comprises an air outflow surface, and the cross-flow fan is disposed at the air outflow surface.

15. The projector as claimed in claim 10, wherein the housing comprises an air inflow surface, and the cross-flow fan is disposed at the air inflow surface.

16. The projector as claimed in claim 10, wherein the housing comprises an air outflow surface and an air inflow surface, the number of the cross-flow fans is two, and the cross-flow fans are disposed at the air outflow surface and the air inflow surface, respectively.

17. The projector as claimed in claim 10, wherein the cross-flow fan has a length of 12 cm.

18. The electronic device as claimed in claim 10, wherein the cross-flow fan has a height of 4 cm.
